(19) United States
(12) Patent Application Publication
(10) Pub. No.: US 2025/0017129 A1
(43) Pub. Date: Jan. 16, 2025

(54) METHODS AND APPARTUS TO DETERMINE AGRICULTURAL OPERATIONS FOR AGRICULTURAL PRODUCTION

(71) Applicant: Deere & Company, Moline, IL (US)

(72) Inventors: Philipp F. Twickler, MÜNSTER (DE); Rupali Patil, Evans, GA (US); Matthias Meyer, Kaiserslautern (DE); Benjamin Buechner, Bottenbach (DE)

(21) Appl. No.: 18/762,340

(22) Filed: Jul. 2, 2024

Related U.S. Application Data
(60) Provisional application No. 63/513,492, filed on Jul. 13, 2023.

(51) Int. Cl. A01B 79/00; A01B 79/02

(52) U.S. Cl. CPC A01B 79/005; A01B 79/02

(57) ABSTRACT

Systems, apparatus, articles of manufacture, and methods are disclosed to determine agricultural operations for agricultural production. The system includes instructions to determine a first agricultural operation; cause a performance of the first agricultural operation; receive a record of the performance of the first agricultural operation, the record of the performance of the first agricultural operation to include first information related to a first row where the performance of the first agricultural operation occurred; determine a second agricultural operation to be performed, the determination of the second agricultural operation based on the first information; cause performance of the second agricultural operation, the performance of the second agricultural operation to occur at the first row; and receive a record of the performance of the second agricultural operation, the record of the performance of the second agricultural operation to include second information related to a second row.

### RELATED APPLICATION

This patent claims the benefit of U.S. Provisional Patent Application No. 63/513,492, which was filed on Jul. 13, 2023. U.S. Provisional Patent Application No. 63/513,492 is hereby incorporated herein by reference in its entirety. Priority to U.S. Provisional Patent Application No. 63/513,492 is hereby claimed.

### FIELD OF THE DISCLOSURE

This disclosure relates generally to agricultural operations and, more particularly, to methods and apparatus to determine agricultural operations for agricultural production.

### BACKGROUND

In recent years, many individual operations (e.g., planting, sewing, harvesting, weeding, fertilizing, manure application, etc.) have been utilized to aid crop production. A user (e.g., farmer, operator, etc.) performing the individual operations in precise locations reaps significant improvements in critical productions steps like planting, nurturing, and/or protecting crops. Accordingly, operating and recording the precise location of performance of the operations for agricultural production occurs on different software programs wherein a user controls the timing and planning of each operation.

### BRIEF DESCRIPTION OF THE DRAWINGS

FIG. 1 is a block diagram of an example environment in which an example vehicle operates according to an agricultural operation instruction.

FIG. 2 is a block diagram of an example implementation of the example agricultural operation circuitry of FIG. 1.

FIG. 3 is a first diagram of a first example implementation of the vehicle of FIG. 1 operating according to a series of agricultural operation instructions.

FIG. 4 is a second diagram of a second example implementation of the vehicle of FIG. 1 operating according to an agricultural operation instruction.

FIG. 5 is a third diagram of a third example implementation of the vehicle of FIG. 1 operating according to an agricultural operation instruction.

FIGS. 6-8 are flowcharts representative of example machine-readable instructions and/or example operations that may be executed, instantiated, and/or performed by example programmable circuitry to implement the agricultural operation circuitry of FIG. 2.

FIG. 9 is a block diagram of an example processing platform including programmable circuitry structured to execute, instantiate, and/or perform the example machine-readable instructions and/or perform the example operations of FIGS. 6-8 to implement the agricultural operation circuitry of FIG. 2.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine-readable instructions of FIGS. 6-8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

The planning of individual agricultural operations by a user results in a complicated integration of various software programs and/or past agricultural operations. Particularly, to implement the corn production cycle, there are several overlapping steps (e.g., cover cropping, mulching, slurry injection, tillage, planting, mechanical weed control, chemical weed control, harvest, etc.). In cycles and/or crop management with several overlapping operations, such as the corn production cycle, planning and performing crop management becomes a complicated, difficult task. Particularly, while individual steps of manure application, variable planting, selective spraying, and mechanical weeding are known, an optimized system approach across these steps is not.

Table 1 below shows a detailed overview of the steps for corn farming. In addition to the current state of technology, best practice for the agricultural operation is included. Foundational technology for all agricultural operations include AutoTrac™, AutoPath™ from rows, AutoPath™ from boundary, shared signal (2x John Deere StarFire™ plus 1x RTK), section control, AutoSetup™ and John Deere DataSync setup. For example, a specific John Deere technology to execute the best practice approach for each agricultural operation is shown.

| Agricultural | State of | Best | John Deere |
|---|---|---|---|
| Operation | Technology | Practice | Technology |
| Manure | Dribble bar system | Strip till system | Manure Sensing |
| application | with subsequent | with manure band | |
| | field cultivator | placement in | |
| | application | the soil | |
| | Without | With | |
| | nitrification | nitrification | |
| | inhibitors | inhibitors | |
| Nitrogen rate | Volume rate | Nitrogen rate | |
| | | with HL 3000 | |
| Corn planting | Conventional | Directly over the | Integrated Active |
| | | manure band | Implement Guidance |
| | Fix seed rate | Variable seed rate | (iAG) and application |
| Fertilizer | Conventional, | Reduce inorganic | maps for fertilizer |
| | maximum of | fertilizer, plus | and seeds |
| | inorganic fertilizer | micro granulate | |
| Weeding | Conventional | Mechanical | iAG for mechanical |
| | spraying | weeding and/or | weeding or Active |
| | | band spraying | Implement Guidance |
| | | | (AIG) for band spraying |
| Harvesting | Without | With constituents | Rx fertilizing, equipment |
| | constituents | sensing with | mobile app, AutoLoC |
| | sensing | HarvestLab ™3000 | (length of cut), |
| | | | HarvestLab ™ 3000 |

As demonstrated above, corn farming (e.g., and other agricultural operations, etc.) includes a variety of operations to be performed. The orchestration of these agricultural operations may be difficult given the timing requirements of the operations. Additionally, because the agricultural operations are performed individually, the executed rows (e.g., rows where an agricultural operation was performed) were not recorded to be used in the performance of a subsequent agricultural operation. Therefore, a need exists for a system to allow a user to implement a subsequent agricultural operation using information from a previously performed agricultural operation.

An agricultural system to organize agricultural operations into a single operations center wherein the operations center records information corresponding to a first agricultural operation to plan and manage the implementation of a second agricultural operation is described herein. Particularly, the agricultural system described herein allows a user to achieve regulatory and policy objectives by reducing fertilizer usage and decreasing risks to crop protection. Further, the agricultural system can streamline agricultural operations on a user-driven or autonomous vehicle (e.g., sprayer, harvester, tractor, and/or implement, etc.). In some examples, the agricultural system utilizes a user operations center to allow a user to maximize crop output while significantly minimizing inputs in practical farming operation.

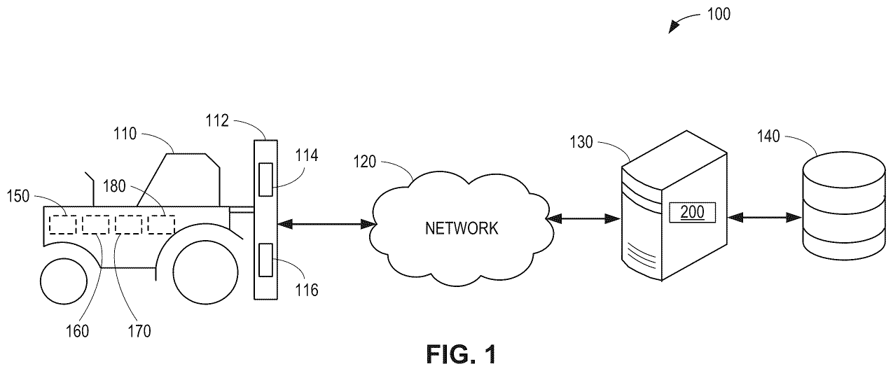

FIG. 1 is a block diagram of an example operational environment 100. In some examples, FIG. 1 depicts an example agricultural production system (e.g., a John Deere Corn Silage System (“CSS”)). An example vehicle 110 is in communication with a network 120, which is also in communication with one or more servers 130. The server 130 utilizes one or more databases 140 to store information used to determine boundaries. In one example, the server 130 accesses information from the database 140 and determines the details of one or more of a first agricultural operation, a second agricultural operation and/or another agricultural operation, which are communicated through the network to the vehicle 110.

As shown in the example, of FIG. 1, the vehicle 110 includes an example position determination system 150, an example navigation system 160, an example data store 170, and an example communication system 180. The communication system 180 receives the agricultural operation information from the server 130 via the network 120 and stores the same in the data store 170. In some examples, data collected by the position determining system 150 may be sent back to the server 130 via the network 120. The navigation system 160, which may include automated driving functionality, controls navigation of the vehicle 110 in accordance with the information in the data store 170, including agricultural operations, boundaries of the plot of land, etc. Thus, the vehicle operations are controlled in accordance with the agricultural operations generated by the server 130.

The example vehicle 110 of FIG. 1 may be an agricultural vehicle (e.g., a tractor, a front loader, a harvester, a cultivator, a mower, or any other suitable vehicle), a construction vehicle, a forestry vehicle, or other work vehicle. In the example of FIG. 1, the vehicle 110 is represented as a tractor; however, other vehicles may additionally or alternatively be included. The vehicle 110 can move between different locations and over different terrain.

In the example of FIG. 1, the vehicle 110 includes an example implement 112. The implement 112 can be a plough, a hoe, a cultivator, a seed drill, irrigation machinery, planting machinery, harvesting machinery, and/or any other agricultural implement.

In this example, the implement includes an electronic control unit (ECU) 114 and a geographic positioning system (GPS) unit 116. The ECU 114 causes the performance of the agricultural operation as the vehicle 110 traverses the plot of land. Further, the GPS 116 records the location(s) of the performance of the agricultural operation as the vehicle 110 traverses the plot of land (e.g., records the location of the vehicle and/or the implement when an agricultural operation is performed, etc.). In some examples, the GPS 116 may send a signal to the ECU 114 to perform the agricultural operation when the GPS 116 records that the vehicle and/or the implement are in a specified position. In some examples, the location(s) of the performance recorded by the GPS 116 is used to determine a subsequent agricultural operation. After recording the performance of the agricultural operation, the GPS 116 sends the data over the example network 120.

The example network 120 of FIG. 1 shuttles communication between the server 130, the vehicle 110, and the implement 112. The example network 120 may be implemented by wireless communication, satellite communication, or other suitable communication modes.

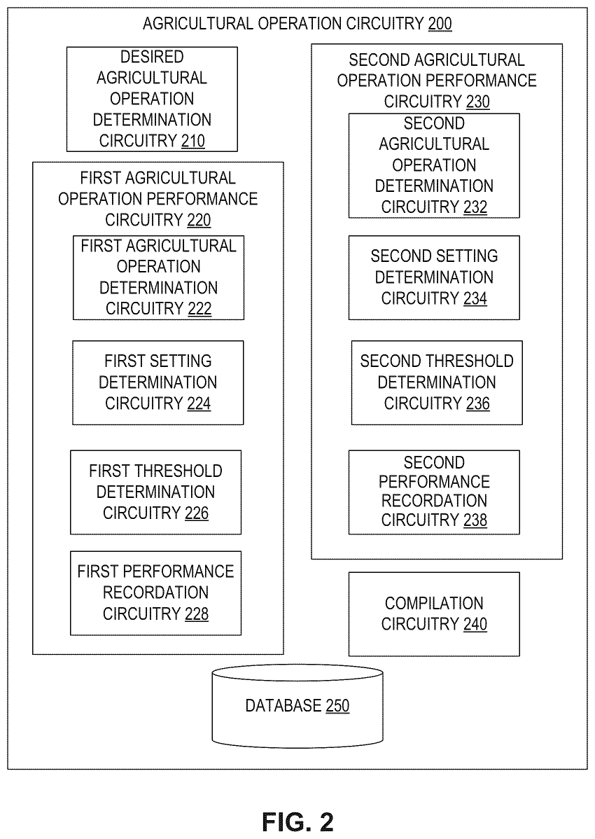

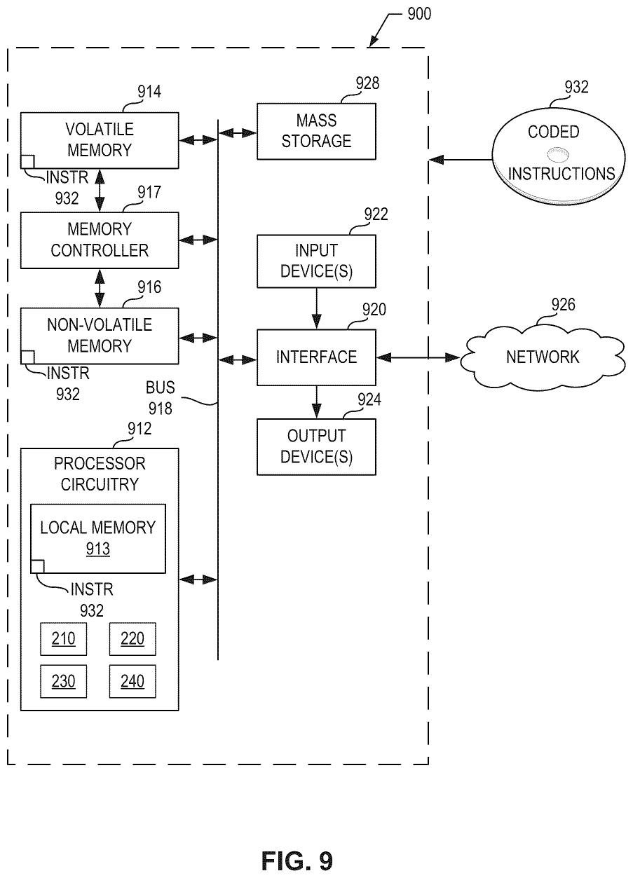

The example server 130 of FIG. 1 may be instantiated, implemented, or performed as described in connection with the processor circuitry of FIGS. 9-12. Further, in the illustrated example of FIG. 1, the server 130 includes agricultural operation circuitry 200. The agricultural operation circuitry 200 is further detailed in connection with FIG. 2.

In some examples, operations are managed through the server 130 (e.g., an online farm management system) to enable the planning and execution of the agricultural operation in a plot of land in a user-friendly and easy manner. Additionally, other agronomic benefits include (1) reduced water losses, improved root development, and reduced erosion risk; (2) reduced application of inorganic fertilizer through precise fertilizer and seed placement; (3) reduced application of chemicals through precise mechanical weeding and band spraying (e.g., up to 66% less chemical applied based on local conditions); (4) increased yield gains (e.g., preliminary trials show yield gains between 10-20% compared to traditional systems); and (5) reduced nitrogen losses (e.g., up to 77% reduced nitrogen losses) and reduced carbon dioxide losses (e.g., up to 38% carbon dioxide reduction).

The example database 140 of FIG. 1 stores information concerning agricultural operations, plots of land, machine operations, etc., for use by the server 130. The example database 140 may be implemented by magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

While in the example of FIG. 1, the server 130 and the database 140 are shown separate from the vehicle 110 and implement 112, in other examples the functionality described herein as associated with the server may be implemented within the vehicle 110 and/or implement 112. For example, the vehicle 110 and/or the implement 112 may be equipped with processing power, such as a server, and data storage, such as a database, to implement the functions associated with the server 130 and the database 140 described herein.

In FIG. 1, the example position determination system 150 may be a GNSS receiver included in the vehicle 110. This example position determination system 150 may be equipped with Global Navigation Satellite System (GNSS), Global Positioning Systems (GPS), Light Detection and Ranging (LIDAR), Radio Detection and Ranging (RADAR), Sound Navigation and Ranging (SONAR), telematics sensors, etc. In some examples, the example GNSS receiver may use differential correction such as (a) precise point positioning (PPP) mode or wide area augmentation, or (b) RTK (real time kinematic) mode. The RTK system or mode requires at least one local base station that provides correction information wirelessly to the GNSS receiver with a wireless communications device that can receive correction data from the local base station in RTK. Similarly, for the GNSS receiver operating as PPP or PPP mode has a network of reference GNSS stations at known locations that provide a correction signal to the GNSS receiver on the vehicle 110 via a wireless communications device, such as satellite communications device. In some examples, this position determination system 150 may be connected to a central server (e.g., John Deere Operations Center “OpsCenter”, server 130 of FIG. 1) where collected agricultural operation data is stored from past operations on that plot of land. Each time the same plot of land has equipment travel over the land or perform an operation on that land, such as tilling, planting, spraying, harvesting, or performing other work tasks, agricultural operation data is collected to be stored in the database 140 for use in successive machine operation on that plot of land.

The navigation system 160 receives, processes, and transmits example instructions to control operation of the vehicle 110. The navigation system 160 may also receive instructions to perform various machine operations such as, tilling, planting, spraying, harvesting, or other work tasks. Additionally or alternatively, the navigation system 160 may transmit information of the terrain and machine operation performed for a specific plot of land to the server 130. In some examples, the navigation system 160 is instantiated by a guidance and/or path planning system (e.g., John Deere AutoPath™, John Deere AutoTrac™, John Deere Active Implement Guidance™ (iAIG), etc.). In these examples, the navigation system 160 works with the server 130 to enable precision in manure application, crop planting, crop protection, crop nutrition, and other agricultural operations. Particularly, the navigation system 160 can record the position of executed rows (e.g., rows where an agricultural operation has been performed) so that the recorded positions may be used in subsequent field operations to enable precise operation. In some examples, the navigation system 160 can forward the positions of the executed rows to the server 130 and the database 140. Therefore, the navigation system 160 enables successive agricultural operations to be performed in the precise location of a previously performed agricultural operation through reuse of the location data collected during the previous agricultural operation. Further, the navigation system 160 may record other data correlated to the field operation (e.g., may implement the John Deere HarvestLab™ 3000 to record yield and forage quality, etc.). By documenting yields and constituents, protein-removal maps can be created. These are used to calculate nitrogen use efficiency and to create fertilizer and seed application maps for the next season.

The data store 170 receives, processes, and transmits example instructions from the server 130. The data store 170 may be a memory, and store instructions for later or contemporary use by the vehicle 110. The instructions contained in the data store 170 may correspond to either, or both, vehicle operation instructions or collected data from the plot of land. The data store 170 can receive and store the position of executed rows recorded by the navigation system 160. Additionally, the data store 170 may receive and store other data related to the performance of an agricultural operation (e.g., wind, soil moisture, etc.).

The data store 170 may store, retrieve, read and write one or more of the following items: a curvature module, a linear module, a control unit, and historic heading data. A module means software, electronics, or both. As used herein, heading can refer to: (1) an angular direction of travel of the vehicle 110 with reference to due North or magnetic North, or (2) a yaw or yaw angle of the vehicle 110 with reference to coordinate system, such as a Cartesian coordinate system.

The control unit of the data store 170 includes logic for deciding whether to use the curvature module or the linear module for estimating the projected heading of the vehicle 110 at any given time or at a current location of the vehicle 110. For example, the control unit or the data processor is arranged to determine the estimated curvature and compare the estimated curvature to a threshold to decide whether or not to use the curvature or the linear module for estimating the projected heading of the vehicle 110 or deciding between the first guidance mode and the second guidance mode. The data processor or control unit may determine the estimated curvature of the historic path of the vehicle 110 in accordance with the following equation: C=ΔP/D, where C is the curvature, ΔP is the path heading change (e.g., recent historic path heading change), and D is the path distance (e.g., recent historic path distance traversed).

In one example, the curvature module includes software instructions (files, or data) related to determining or estimating a projected heading of a vehicle 110 based on historic path heading data stored in, retrieved from or associated with the data store 170. For example, a curvature module is configured to determine a secondary guidance path based on a running average (e.g. mode, mean or median) of the recent historic path heading consistent with a curvature limit of a curved path plan if the estimated curvature of the recent historic path heading is greater than, or equal to, a threshold.

In one embodiment, the linear module includes software instructions related to determining or estimating a projected heading of a vehicle 110 based on recent historic path heading data stored in, retrieved from or associated with the data store 170. For example, the linear module determines the secondary guidance path based on a running average (e.g., mode, mean or median) of the recent historic path heading consistent with a linear limit of a curved path plan if the estimated curvature of the recent historic path heading is less than a threshold.

In one embodiment, a location-determining receiver is arranged to determine the secondary guidance path based on the historic path heading consistent with headings estimated by a location-determining receiver for corresponding historic locations of the vehicle 110. The historic path heading may have substantially linear path segments, substantially curved path segments or both.

The communication system 180 receives, processes, and transmits example instructions from the server 130 to the data store 170 and the navigation system 160. The communication system 180 may communicate instructions concerning agricultural operations, maps, sensor data, etc. The communication system may be implemented as a wireless system, a cellular system, a satellite system, a radio system, etc.

FIG. 2 is a block diagram representative of the example agricultural operation circuitry 200 of FIG. 1. The agricultural operation circuitry includes example desired agricultural operation determination circuitry 210, example first agricultural operation performance circuitry 220, example first agricultural operation determination circuitry 222, example first setting determination circuitry 224, example first threshold determination circuitry 226, example first performance recordation circuitry 228, example second agricultural operation performance circuitry 230, example second agricultural operation determination circuitry 232, example second setting determination circuitry 234, example second threshold determination circuitry 236, example second performance recordation circuitry 238, example compilation circuitry 240, and an example database 250. The agricultural operation circuitry 200 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the agricultural operation circuitry 200 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

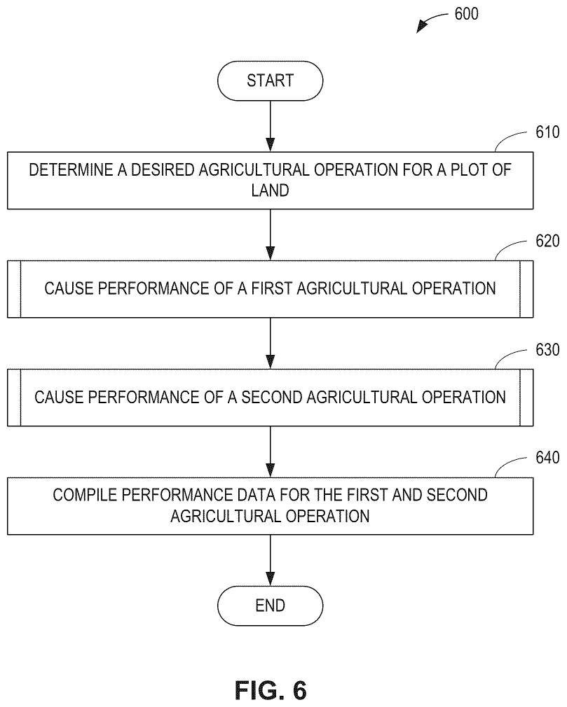

The agricultural operation circuitry 200 includes desired agricultural operation determination circuitry 210. The desired agricultural operation determination circuitry 210 is to determine a desired agricultural operation for a plot of land. In some examples, the user/API interface circuitry 210 seeks a user input to determine what stage of the crop cycle that the plot of land is currently in and/or what agricultural operation to apply. In some examples, the position determination system 150 registers the position of the vehicle 110 as near the plot of land. Then, the data store 170 matches the position of the vehicle 110 with a last-performed agricultural operation on the plot of land. Then, the communication system 180 sends to the desired agricultural operation determination circuitry 210 the last-performed agricultural operation on the plot of land. Then, either the user or default prescriptions enable the desired agricultural operation determination circuitry 210 to determine the desired agricultural operation for the plot of land. In some examples, the desired agricultural operation determination circuitry 210 is instantiated by programmable circuitry executing desired agricultural operation determination instructions and/or configured to perform operations such as those represented by the flowchart of FIG. 6 (block 610).

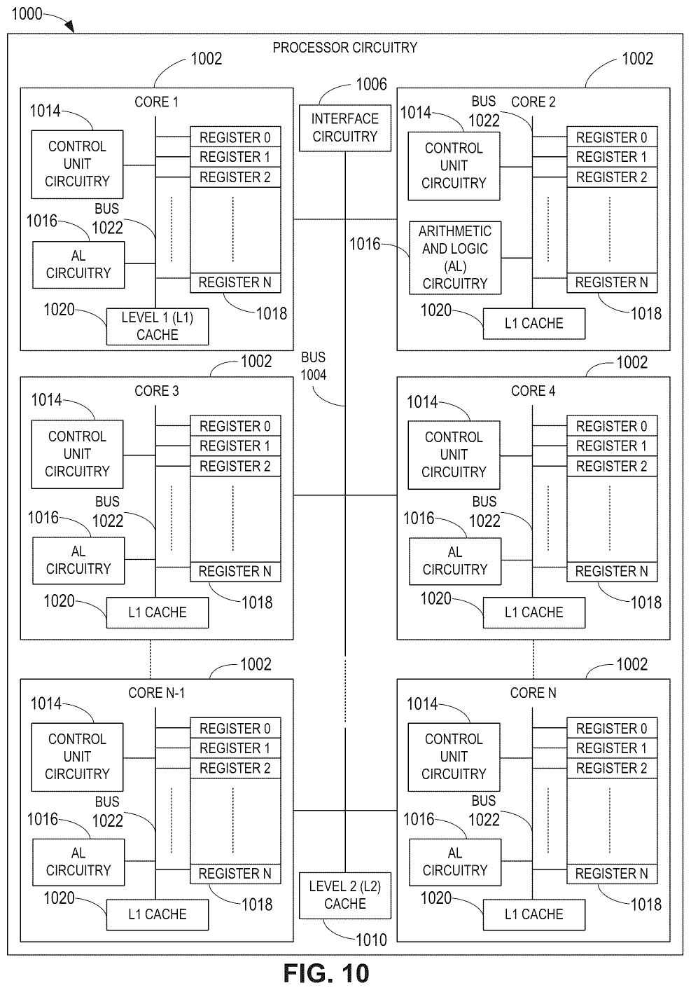

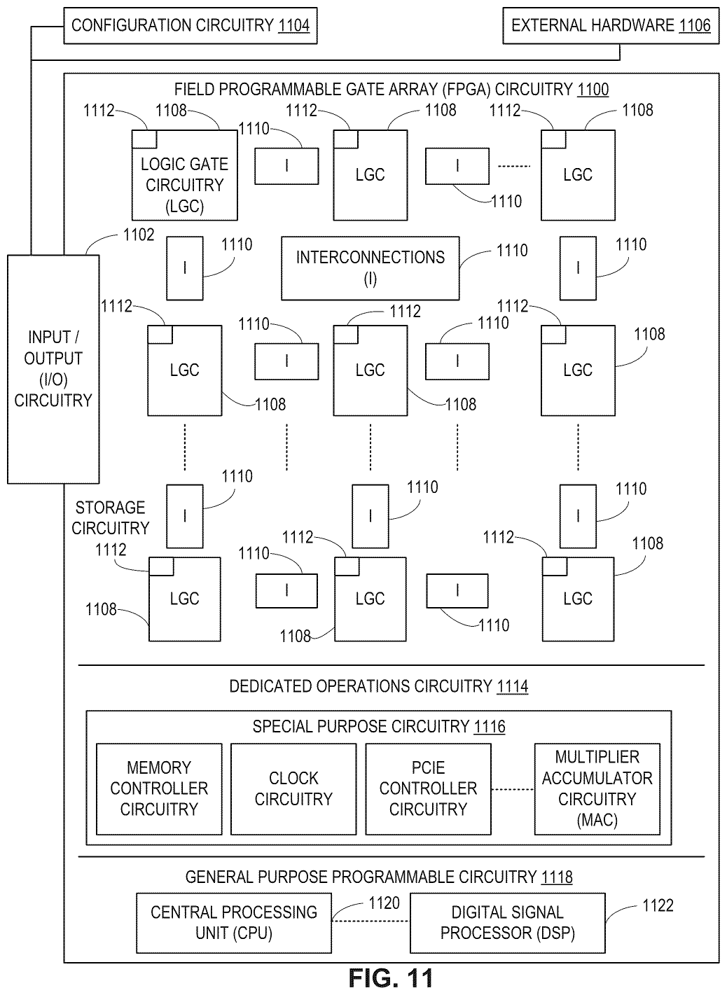

In some examples, the agricultural operation circuitry 200 includes means for determining a desired agricultural operation for a plot of land. For example, the means for determining the desired agricultural operation for the plot of land may be implemented by desired agricultural operation circuitry 210. In some examples, the desired agricultural operation circuitry 210 may be instantiated by programmable circuitry such as the example programmable circuitry 912 of FIG. 9. For instance, the desired agricultural operation circuitry 210 may be instantiated by the example microprocessor 1000 of FIG. 10 executing machine executable instructions such as those implemented by at least block 610 of FIG. 6. In some examples, the desired agricultural operation circuitry 210 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the desired agricultural operation circuitry 210 may be instantiated by any other combination of hardware, software, and/or firmware. For example, the desired agricultural operation circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

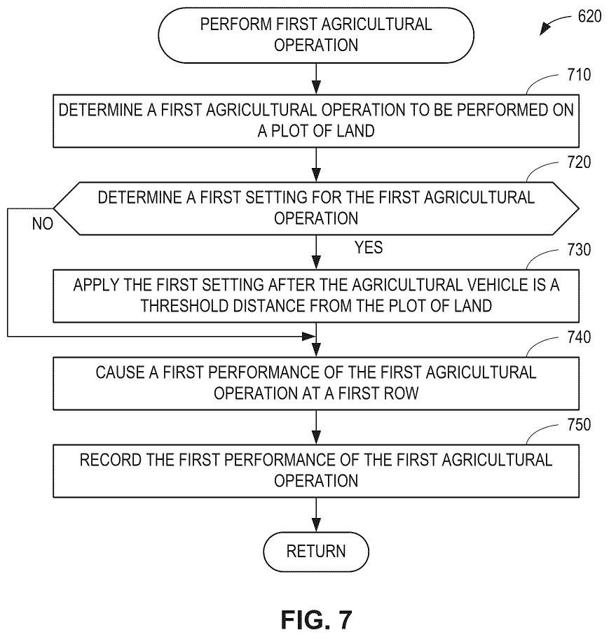

The agricultural operation circuitry 200 includes first agricultural operation performance circuitry 220. The first agricultural operation performance circuitry 220 causes performance of the first agricultural operation. In some examples, the first agricultural operation performance circuitry 220 causes a first performance of the first agricultural operation at a first row of the plot of land. In some examples, to cause the performance of the first agricultural operation, the first agricultural operation performance circuitry 220 utilizes first agricultural operation determination circuitry 222, first setting determination circuitry 224, first threshold determination circuitry 226, and first performance recordation circuitry 228. In some examples, the first agricultural operation performance circuitry 210 is instantiated by programmable circuitry executing first agricultural operation performance instructions and/or configured to perform operations such as those represented by the flowcharts of FIGS. 6 and 7 (blocks 620 and 740, respectively).

In some examples, the agricultural operation circuitry 200 includes means for causing performance of the first agricultural operation. For example, the means for causing performance of the first agricultural operation may be implemented by first agricultural operation performance circuitry 220. In some examples, the first agricultural operation performance circuitry 220 may be instantiated by programmable circuitry such as the example programmable circuitry 912 of FIG. 9. For instance, the first agricultural operation performance circuitry 220 may be instantiated by the example microprocessor 1000 of FIG. 10 executing machine executable instructions such as those implemented by at least block 620 of FIG. 6 and block 740 of FIG. 7. In some examples, the first agricultural operation performance circuitry 220 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the first agricultural operation performance circuitry 220 may be instantiated by any other combination of hardware, software, and/or firmware. For example, the first agricultural operation performance circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The first agricultural operation circuitry includes first agricultural operation determination circuitry 222. The first agricultural operation determination circuitry 222 determines a first agricultural operation to be performed on the plot of land. The first agricultural operation can be the desired agricultural operation, another agricultural operation to prepare for the desired agricultural operation (e.g., an intermediate agricultural operation), and/or any other agricultural operation. In some examples, the first agricultural operation determination circuitry 222 determines the first agricultural operation through user input and/or a default prescription based on the desired agricultural operation and/or a previously performed agricultural operation. In some examples, the first agricultural operation determination circuitry 222 is instantiated by programmable circuitry executing first agricultural operation determination instructions and/or configured to perform operations such as those represented by the flowchart of FIG. 7 (block 710).

In some examples, the agricultural operation circuitry 200 includes means for determining a first agricultural operation to be performed on the plot of land. For example, the means for determining the first agricultural operation to be performed on the plot of land may be implemented by first agricultural operation determination circuitry 222. In some examples, the first agricultural operation determination circuitry 222 may be instantiated by programmable circuitry such as the example programmable circuitry 912 of FIG. 9. For instance, the first agricultural operation determination circuitry 220 may be instantiated by the example microprocessor 1000 of FIG. 10 executing machine executable instructions such as those implemented by at least block 710 of FIG. 7. In some examples, the first agricultural operation determination circuitry 222 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the first agricultural operation determination circuitry 222 may be instantiated by any other combination of hardware, software, and/or firmware. For example, the first agricultural operation determination circuitry 222 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The first agricultural operation performance circuitry 220 includes first setting determination circuitry 224. The first setting determination circuitry determines a first setting for the first agricultural operation. The first setting includes a mode of operation for a vehicle (e.g., the vehicle 110, etc.) to implement the first agricultural operation. The mode of operation can include positioning an implement of the vehicle to perform the first agricultural operation (e.g., a harvest operation, a weeding operation, a seeding operation, a tilling operation, and/or another agricultural operation). The first setting may be inputted by the user via the first setting determination circuitry 224. In these examples, the user can specify operation information (e.g., the type of vehicle, the exact crop (e.g., corn) variety, the selection of a plot of land, field specific details (e.g., working direction, track lines, etc.), application maps for variable rate planting and/or fertilizing, etc.). In other examples, the first setting determination circuitry 224 can determine the first setting based on the determined first agricultural operation from the first agricultural operation determination circuitry 222. In some examples, the first setting determination circuitry 224 is instantiated by programmable circuitry executing first setting determination instructions and/or configured to perform operations such as those represented by the flowchart of FIG. 7 (block 720).

In some examples, the agricultural operation circuitry 200 includes means for determining a first setting for a first agricultural operation. For example, the means for determining the first setting for the first agricultural operation may be implemented by first setting determination circuitry 224. In some examples, the first setting determination circuitry 224 may be instantiated by programmable circuitry such as the example programmable circuitry 912 of FIG. 9. For instance, the first setting determination circuitry 224 may be instantiated by the example microprocessor 1000 of FIG. 10 executing machine executable instructions such as those implemented by at least block 720 of FIG. 7. In some examples, the first setting determination circuitry 224 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the first setting determination circuitry 224 may be instantiated by any other combination of hardware, software, and/or firmware. For example, the first setting determination circuitry 224 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The first agricultural operation performance circuitry 220 includes first threshold determination circuitry 226. The first threshold determination circuitry 226 applies the first setting (e.g., wirelessly via John Deere JD Link and MTG or other wireless connection means) after the vehicle is a threshold distance from the plot of land. In some examples, the first setting is automatically loaded to the vehicle by the first threshold determination circuitry 226 after a determination that the vehicle is, and/or is within, a threshold distance from the plot of land. In other examples, the first threshold determination circuitry 226 may send a notification to a user. In these examples, the notification enables the user to load the first setting to an in-cab display of the vehicle. The display allows the user to apply the first setting. In some examples, the user may manually input the threshold distance into the threshold determination circuitry 226. In other examples, the threshold distance is a default measurement based on the agricultural operation and/or the plot of land. In some examples, the first threshold determination circuitry 226 is instantiated by programmable circuitry executing first threshold determination instructions and/or configured to perform operations such as those represented by the flowchart of FIG. 7 (block 730).

In some examples, the agricultural operation circuitry 200 includes means for applying a first setting after a vehicle is a threshold distance from a plot of land. For example, the means for applying the first setting after the vehicle is the threshold distance from the plot of land may be implemented by first threshold determination circuitry 226. In some examples, the first threshold determination circuitry 226 may be instantiated by programmable circuitry such as the example programmable circuitry 912 of FIG. 9. For instance, the first threshold determination circuitry 226 may be instantiated by the example microprocessor 1000 of FIG. 10 executing machine executable instructions such as those implemented by at least block 730 of FIG. 7. In some examples, the first threshold determination circuitry 226 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the first threshold determination circuitry 226 may be instantiated by any other combination of hardware, software, and/or firmware. For example, the first threshold determination circuitry 226 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The first agricultural operation performance circuitry 220 includes first performance recordation circuitry 228. The first performance recordation circuitry 228 records the first performance of the first agricultural operation. In some examples, the first performance recordation circuitry 228 records the row (e.g., the first row, geo-referenced coordinates of the first row, etc.) where the first performance occurred. Additionally, the first performance recordation circuitry 228 can record the placement of slurry bands (e.g., the deposition of the slurry bands) and enable the placement of a seed (e.g., corn, etc.) on top of the slurry band. Further, the first performance recordation circuitry 228 can record the health of the soil, the nutrient content, the locations of seeds in a row, the locations of slurry bands (e.g., manure), the location of weeding operations, the location of chemical weeding substance placement, and/or other agricultural operations or data that may be sensed by the vehicle during performance of the first agricultural operation. In some examples, the first performance recordation circuitry 228 is instantiated by programmable circuitry executing first performance recordation instructions and/or configured to perform operations such as those represented by the flowchart of FIG. 7 (block 750).

In some examples, the agricultural operation circuitry 200 includes means for recording a first performance of a first agricultural operation. For example, the means for applying the first performance of the first agricultural operation may be implemented by first performance recordation circuitry 228. In some examples, the first performance recordation circuitry 228 may be instantiated by programmable circuitry such as the example programmable circuitry 912 of FIG. 9. For instance, the first performance recordation circuitry 228 may be instantiated by the example microprocessor 1000 of FIG. 10 executing machine executable instructions such as those implemented by at least block 750 of FIG. 7. In some examples, the first performance recordation circuitry 228 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the first performance recordation circuitry 228 may be instantiated by any other combination of hardware, software, and/or firmware. For example, the first performance recordation circuitry 228 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

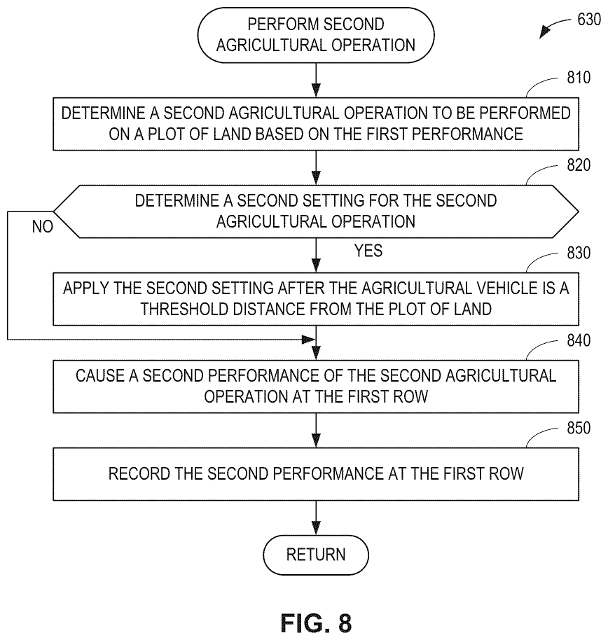

The agricultural operation circuitry 200 includes second agricultural operation performance circuitry 230. The second agricultural operation performance circuitry 230 causes performance of a second agricultural operation. In some examples, the second agricultural operation performance circuitry 230 causes a second performance of the second agricultural operation at the first row. In some examples, to cause the performance of the first agricultural operation, the second agricultural operation performance circuitry 230 utilizes second agricultural operation determination circuitry 232, second setting determination circuitry 234, second threshold determination circuitry 236, and second performance recordation circuitry 238. In some examples, the second agricultural operation performance circuitry 230 is instantiated by programmable circuitry executing second agricultural operation performance instructions and/or configured to perform operations such as those represented by the flowcharts of FIGS. 6 and 8 (blocks 630 and 840, respectively).

In some examples, the agricultural operation circuitry 200 includes means for causing performance of a second agricultural operation. For example, the means for causing performance of the second agricultural operation may be implemented by second agricultural operation performance circuitry 230. In some examples, the second agricultural operation performance circuitry 230 may be instantiated by programmable circuitry such as the example programmable circuitry 912 of FIG. 9. For instance, the second agricultural operation performance circuitry 230 may be instantiated by the example microprocessor 1000 of FIG. 10 executing machine executable instructions such as those implemented by at least block 630 of FIG. 6 and block 840 of FIG. 8. In some examples, the second agricultural operation performance circuitry 230 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the second agricultural operation performance circuitry 230 may be instantiated by any other combination of hardware, software, and/or firmware. For example, the second agricultural operation performance circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The second agricultural operation performance circuitry 230 includes second agricultural operation determination circuitry 232. The second agricultural operation determination circuitry 232 determines the second agricultural operation to be performed on the plot of land based on the first performance. In other words, based on the recording of the first performance recordation circuitry 228 of the first performance of the first agricultural operation, the second agricultural operation determination circuitry 232 determines the second agricultural operation. In some examples, the second agricultural operation is based on whether the first agricultural operation was successfully and/or accurately performed. In other examples, the second agricultural operation is performed to implement the next operation in a crop cycle (e.g., the second agricultural operation is tillage after the first performance of the first agricultural operation of slurry injection, etc.). In some examples, the second agricultural operation is the desired agricultural operation. In other examples, the second agricultural operation is another operation in the crop cycle for the plot of land and/or any other suitable agricultural operation. In some examples, the second agricultural operation determination circuitry 232 is instantiated by programmable circuitry executing second agricultural operation determination instructions and/or configured to perform operations such as those represented by the flowchart of FIG. 8 (block 810).

In some examples, the agricultural operation circuitry 200 includes means for determining a second agricultural operation to be performed on a plot of land based on a first performance. For example, the means for determining the second agricultural operation may be implemented by second agricultural operation determination circuitry 232. In some examples, the second agricultural operation determination circuitry 232 may be instantiated by programmable circuitry such as the example programmable circuitry 912 of FIG. 9. For instance, the second agricultural operation determination circuitry 232 may be instantiated by the example microprocessor 1000 of FIG. 10 executing machine executable instructions such as those implemented by at least block 810 of FIG. 8. In some examples, the second agricultural operation determination circuitry 232 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the second agricultural operation determination circuitry 232 may be instantiated by any other combination of hardware, software, and/or firmware. For example, the second agricultural operation determination circuitry 232 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The second agricultural operation performance circuitry 230 includes second setting determination circuitry 234. The second setting determination circuitry 234 determines a second setting for the second agricultural operation. The second setting includes a mode of operation for a vehicle to implement the second agricultural operation. The mode of operation can include positioning an implement of the vehicle to perform the second agricultural operation (e.g., a harvest operation, a weeding operation, a seeding operation, a tilling operation, and/or another agricultural operation). The second setting may be inputted by the user via the second setting determination circuitry 234. In these examples, the user can specify operation information (e.g., the type of vehicle, the exact crop (e.g., corn) variety, the selection of a plot of land, field specific details (e.g., working direction, track lines, etc.), application maps for variable rate planting and/or fertilizing, etc.). In other examples, the second setting determination circuitry 234 can determine the second setting based on the determined second agricultural operation of the second agricultural operation determination circuitry 232. In some examples, the second setting determination circuitry 234 is instantiated by programmable circuitry executing second setting determination instructions and/or configured to perform operations such as those represented by the flowchart of FIG. 8 (block 820).

In some examples, the agricultural operation circuitry 200 includes means for determining a second setting for the second agricultural operation. For example, the means for determining the second setting may be implemented by second setting determination circuitry 234. In some examples, the second setting determination circuitry 234 may be instantiated by programmable circuitry such as the example programmable circuitry 912 of FIG. 9. For instance, the second setting determination circuitry 234 be instantiated by the example microprocessor 1000 of FIG. 10 executing machine executable instructions such as those implemented by at least block 820 of FIG. 8. In some examples, the second setting determination circuitry 234 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the second setting determination circuitry 234 may be instantiated by any other combination of hardware, software, and/or firmware. For example, the second setting determination circuitry 234 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The second agricultural operation performance circuitry 230 includes second threshold determination circuitry 236. The second threshold determination circuitry 236 applies the second setting (e.g., wirelessly via John Deere JD Link and MTG or other wireless connection means) after the vehicle is a threshold distance from the plot of land. In some examples, the second setting is automatically loaded to the vehicle by the second threshold determination circuitry 236 after a determination that the vehicle is, and/or is within, the threshold distance from the plot of land. In other examples, the second threshold determination circuitry 236 may send a notification to a user. In these examples, the notification enables the user to load the second setting to an in-cab display of the vehicle. The display allows the user to apply the second setting. In some examples, the user may manually input the threshold distance into the second threshold determination circuitry 236. In other examples, the threshold distance is a default measurement based on the agricultural operation. In some examples, the second threshold determination circuitry 236 is instantiated by programmable circuitry executing first setting determination instructions and/or configured to perform operations such as those represented by the flowchart of FIG. 8 (block 830).

In some examples, the agricultural operation circuitry 200 includes means for applying a second setting after the vehicle is a threshold distance from a plot of land. For example, the means for applying the second setting may be implemented by second threshold determination circuitry 236. In some examples, the second threshold determination circuitry 236 may be instantiated by programmable circuitry such as the example programmable circuitry 912 of FIG. 9. For instance, second threshold determination circuitry 236 be instantiated by the example microprocessor 1000 of FIG. 10 executing machine executable instructions such as those implemented by at least block 830 of FIG. 8. In some examples, the second threshold determination circuitry 236 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the second threshold determination circuitry 236 may be instantiated by any other combination of hardware, software, and/or firmware. For example, the second threshold determination circuitry 236 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The second agricultural operation performance circuitry 230 includes second performance recordation circuitry 238. The second performance recordation circuitry 238 records a second performance of the second agricultural operation at the first row. In some examples, the second performance recordation circuitry 238 records the rows (e.g., the first row, etc.) where the second performance occurred. Additionally, the second performance recordation circuitry 238 can record the placement of slurry bands and enable the placement of a seed (e.g., corn, etc.) on top of the slurry band. Further, the second performance recordation circuitry 238 can record the health of the soil, the nutrient content, the locations of seeds in a row, the locations of slurry bands (e.g., manure), the location of weeding operations, the location of chemical weeding substance placement, and/or other agricultural operations or data that may be sensed by the vehicle during performance of the first agricultural operation. In some examples, the second performance recordation circuitry 238 records the second performance based on the recordation of the first performance of the first row and a factor of the second performance of the second agricultural operation. The factor of the second performance of the second agricultural operation can include an elevation of the plot of land, an angle of the agricultural vehicle during performance of the second agricultural operation, and other external (e.g., relative to the vehicle) variables. In some examples, the second performance recordation circuitry 238 is instantiated by programmable circuitry executing second performance recordation instructions and/or configured to perform operations such as those represented by the flowchart of FIG. 8 (block 850).

In some examples, the agricultural operation circuitry 200 includes means for recording a second performance at the first row. For example, the means for recording the second performance may be implemented by second performance recordation circuitry 238.

In some examples, the second performance recordation circuitry 238 may be instantiated by programmable circuitry such as the example programmable circuitry 912 of FIG. 9. For instance, the second performance recordation circuitry 238 be instantiated by the example microprocessor 1000 of FIG. 10 executing machine executable instructions such as those implemented by at least block 850 of FIG. 8. In some examples, the second performance recordation circuitry 238 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the second performance recordation circuitry 238 may be instantiated by any other combination of hardware, software, and/or firmware. For example, the second performance recordation circuitry 238 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The agricultural operation circuitry 200 includes compilation circuitry 240. The compilation circuitry 240 compiles performance data for the first agricultural operation and the second agricultural operation. In some examples, the compilation circuitry 240 compiles the first performance data and the second performance data to generate a combined performance data log showing the geographic location of the occurrence of the first agricultural operation and the second agricultural operation. In some examples, the compilation circuitry 240 displays the combined performance data log to the user. Further, the compilation circuitry 240 may send the combined performance data log to the desired agricultural operation determination circuitry 210 to determine a third agricultural operation to instantiate. In some examples, the compilation circuitry 240 is instantiated by programmable circuitry executing compilation instructions and/or configured to perform operations such as those represented by the flowchart of FIG. 6 (block 640).

In some examples, the agricultural operation circuitry includes means for compiling performance data for the first agricultural operation and the second agricultural operation. For example, the means for compiling may be implemented by compilation circuitry 240. In some examples, the compilation circuitry 240 may be instantiated by programmable circuitry such as the example programmable circuitry 912 of FIG. 9. For instance, the compilation circuitry 240 be instantiated by the example microprocessor 1000 of FIG. 10 executing machine executable instructions such as those implemented by at least block 640 of FIG. 6. In some examples, the compilation circuitry 240 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the compilation circuitry 240 may be instantiated by any other combination of hardware, software, and/or firmware. For example, the compilation circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The agricultural operation circuitry 200 includes a database 250. The database 250 may store information and/or data corresponding to the first agricultural operation, the second agricultural operation, the first performance, the second performance, the first setting, the second setting, the first threshold, the second threshold, and/or other agricultural information data. The agricultural operation circuitry 200 may pull from the database 250 data corresponding to a previously performed agricultural operation to determine an agricultural operation to apply.

While an example manner of implementing the agricultural operation circuitry 200 of FIG. 1 is illustrated in FIG. 2, one or more of the elements, processes, and/or devices illustrated in FIG. 2 may be combined, divided, re-arranged, omitted, eliminated, and/or implemented in any other way. Further, the desired agricultural operation determination circuitry 210, the first agricultural operation performance circuitry 220, the first agricultural operation determination circuitry 222, the first setting determination circuitry 224, the first threshold determination circuitry 226, the first performance recordation circuitry 228, the second agricultural operation performance circuitry 230, the second agricultural operation determination circuitry 232, the second setting determination circuitry 234, the second threshold determination circuitry 236, the second performance recordation circuitry 238, the compilation circuitry 240, and/or, more generally, the example agricultural operation circuitry 200 of FIG. 2, may be implemented by hardware alone or by hardware in combination with software and/or firmware. Thus, for example, any of the desired agricultural operation determination circuitry 210, the first agricultural operation performance circuitry 220, the first agricultural operation determination circuitry 222, the first setting determination circuitry 224, the first threshold determination circuitry 226, the first performance recordation circuitry 228, the second agricultural operation performance circuitry 230, the second agricultural operation determination circuitry 232, the second setting determination circuitry 234, the second threshold determination circuitry 236, the second performance recordation circuitry 238, the compilation circuitry 240, and/or, more generally, the example agricultural operation circuitry 200, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example agricultural operation circuitry 200 of FIG. 2 may include one or more elements, processes, and/or devices in addition to, or instead of, those illustrated in FIG. 2, and/or may include more than one of any or all of the illustrated elements, processes and devices.

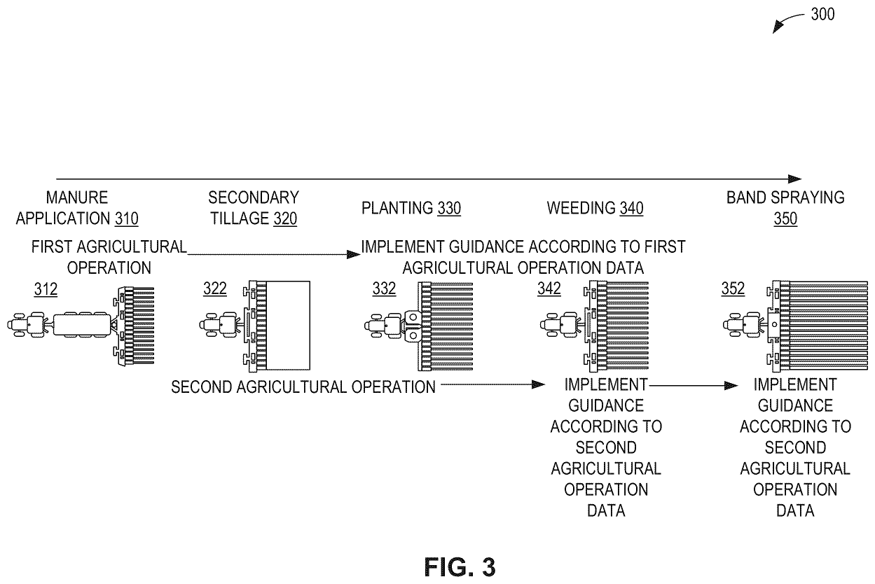

FIG. 3 is a diagram representative of an environment 300 in which the vehicle 110 of FIG. 1 is implemented. In the environment 300, the vehicle 110 performs agricultural operations based on stored previous agricultural information (e.g., the vehicle 110 performs a first agricultural operation and a second agricultural operation where the performance of the second agricultural operation is based on the performance of the first agricultural operation, etc.). The example of FIG. 3 starts with manure (e.g., slurry band) application 310. In this example, the first agricultural operation is the manure application 310. Further, the diagram 312 shows various rows that the vehicle 110 traverses performing the manure application 310. The agricultural operation circuitry 200 records the location of the placement of the manure as these rows. Further, in some examples, the vehicle 110 may store information corresponding to the exact placement of manure within the rows (e.g., every three feet, etc.). In these examples, the placement of the manure is important for crop production as precise placement of the seed above the slurry band guarantees significant nutrient savings. While the placement of manure is one example, other agricultural operations and/or process can be performed using the location data of a previous agricultural operation to ensure precise placement (e.g., weeding after seeding, spraying after planting, etc.).

Then, the vehicle 110 performs secondary tillage 320. The secondary tillage 320 occurs at the location of the first agricultural operation (e.g., where the manure application 310 occurred, etc.). As shown in the diagram 322, the secondary tillage obfuscates the locations of the rows where the manure application 310 occurred. Therefore, the recording of the manure application 310 (e.g., first manure application), is essential for subsequent agricultural operations after the secondary tillage 320. Further, in some examples, secondary tillage 320 may cause changes in the location of the manure, and the vehicle 110 may update the location of the manure in the first agricultural operation data. In the example of FIG. 3, the performance of secondary tillage 320 after the manure application 310 allows for ideal seedbed preparation for best initial growing conditions and subsequent high-speed, high-precision mechanical weeding applications. In particular, secondary tillage 320 can be performed in the exact location of the manure application 310 to allow for precise preparation of the seedbed.

After secondary tillage 320, planting 330 occurs according to the first agricultural operation data. As described above, the process of secondary tillage 320 obfuscates the location of the application of the manure from a user. Therefore, performing the planting 330 in accordance with the locations of manure recorded in the first agricultural operation data ensures that the seed is planted over the slurry band. In the example of FIG. 3, an implement of the vehicle 110 performs planting 330 according to the first agricultural operation data. In this example, planting 330 occurs in the locations of the manure application 310 of the first agricultural operation. Therefore, planting 330 occurs where manure application 310 and secondary tillage 30 has occurred, as shown in diagram 332. In this example, as the vehicle 110 plants according to the first agricultural operation, the agricultural operation circuitry 200 records the location of the placement of the seeds as a second agricultural operation. In these examples, there may be a risk of drift of the vehicle 110 in sidehill applications or by other unforeseen external factors. Therefore, recording the location of the placement of the seeds of the second agricultural operation ensures the locations are updated to enable precise subsequent agricultural operations.

After planting 330, the vehicle 110 performs weeding 340. The vehicle 110 uses the second agricultural operation data to weed in locations other than the location of the plants of the planting 330, as shown in diagram 342. In some examples, the vehicle 110 uses an implement guidance to guide an implement to perform weeding 340 according to the second agricultural operation data and/or the first agricultural operation data.

In some examples, to reduce the application of herbicide, precise mechanical weeding is essential. The combination of integrated active implement guidance (e.g., John Deere iAIG™) and vehicle guidance (e.g., John Deere AutoPath™) enables a user to increase mechanical weeding productivity. The implement guidance controls the implement more precisely along AutoPath™ rows at a higher speed. The solution results in less crop damage due to GPS/GNSS based implement steering.

Further, a camera or other visual system is not relied on to enable row recognition. Therefore, because the locations of the seeds and plants are stored for later use, mechanical weeding can start early in a crop production cycle. Even at later stages, or within disturbed corn rows, the mechanical weeding takes place at the same accuracy and speed level. Further, if mechanical weeding does not result in complete weed mitigation, band spraying may be applied.

In the example of FIG. 3, the vehicle 110 performs band spraying 350. Band spraying is performed to control the weeds within corn rows. The vehicle 110 uses the second agricultural operation data to band spray in locations other than the locations of the plants of the planting operation 330, as shown in diagram 352. Further, the vehicle 110 may supplement the second agricultural operation data collected during planting 330 with updated data collected during weeding 340 (e.g., the locations where mechanical weeding occurred, etc.). In some examples, the vehicle 110 uses an implement guidance program to guide an implement to perform the band spaying 350 according to the second agricultural operation data.

While manure application 310, secondary tillage 320, planting 330, weeding 340, and band spraying 350, are shown in the illustrated example of FIG. 3, other agricultural operations may be implemented. Further, there may be more than two agricultural operations recorded by the vehicle 110 (e.g., a third agricultural operation, a fourth agricultural operation, etc.).

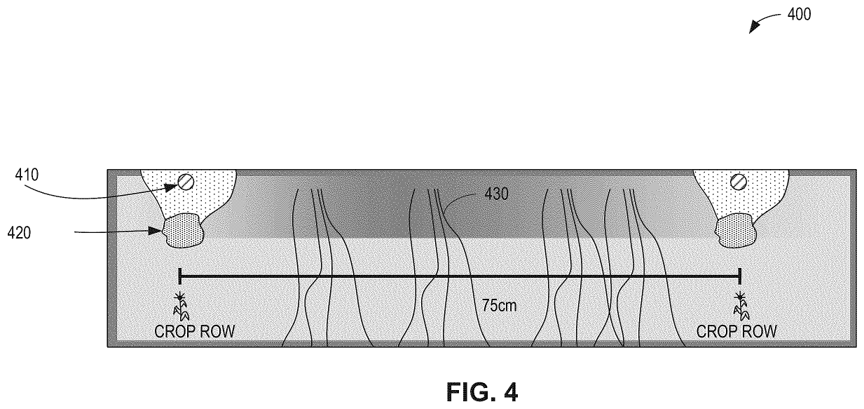

FIG. 4 is an example diagram of an environment 400 where a seed 410 is placed above a manure application 420 (e.g., slurry band, etc.) in a strip-till manure application agricultural operation. The environment 400 depicts the placement of a seed relative to a manure application at a soil profile level. As shown in the example of FIG. 3, the first agricultural operation data is utilized to precisely plant a seed above a manure application (e.g., the first agricultural operation data corresponds to the location of the placement of manure, and the second agricultural operation includes the planting of a seed in the same location as the manure). In some examples, depending on the local conditions and the capability of the vehicle (e.g., planter, etc.), the planting process can be combined with an additional application of fertilizer and micro granulates (e.g., micronutrients, crop protection agents, etc.) to provide productive growing conditions in the early phases of crop (e.g., corn, etc.) growth. In the example of FIG. 4, the crop rows are spaced 75 centimeters apart. Therefore, the vehicle 110 records the location of the manure application as 75 cm apart between rows and plants the seed at these recorded locations. However, in other examples, various distances between rows may be utilized.

In some examples, the strip-till manure application agricultural application is performed using a manure sensing capability of a near infrared radiation (NIR) sensor (e.g., HarvestLab™ 3000 near infrared light sensor, etc.). The strip-till approach limits intensive soil intervention to small strips in the field needed for deep and quick root development towards the manure 420. As the remaining area is left undisturbed, soil capillarity 430 and overall soil health is protected. Further, water losses are reduced.

The use of NIR sensor to perform manure sensing results in the application of the same amount of nutrients (e.g., nitrogen, potassium, phosphorus, etc.) per row. Due to the heterogeneity of different slurry tanks, significant nutrient variations can occur with a volumetric application of slurry. With manure sensing, a relative uniform manure application by row may be performed. Therefore, later placing the seeds directly above the slurry bands ensures quick and deep root development. Therefore, as the whole nutrient depot is utilized by the plant, subsequent mineral fertilizer is not needed at a later stage.

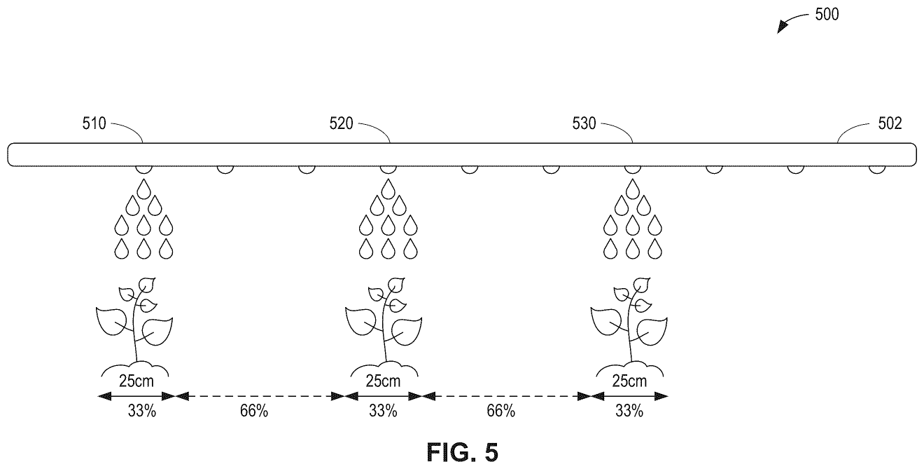

FIG. 5 depicts an environment 500 where an implement 502 of the vehicle 110 of FIG. 1 performs an example agricultural operation. In the example of FIG, 5, locations 510, 520, and 530 of the implement 502 performs band spraying. In some examples, the locations 510, 520, and 530 are controlled to perform an agricultural operation over a certain area. In the example of FIG. 5, the area of the performance of the agricultural operation is 25 cm or 33% of the area between one nozzle and another nozzle (e.g., 33% or ⅓^{rd} of the distance between nozzles 510 and 520 or nozzles 520 and 530, etc.). With 25 cm nozzle spacing on the boom and the option to individually switch nozzles off, a significant reduction (e.g., 66%) of chemical application is achieved, as depicted in FIG. 9. In this situation only every third nozzle needs to be activated to control the weeds within the rows. Implement guidance ensures that the active nozzles run directly over the plants.

Band spraying can be instantiated through a variety of different operations. First, individual nozzle control with a 25 centimeter spacing, allows a user to select which nozzle should be on/off (as shown in FIG. 5). Therefore, in this examples, the valves do not need to be manually closed as the nozzles are programmable and may be selected by a user via a display (e.g., to turn on/off each nozzle). Second, controlling the height of the boom (e.g., using Active Boom Control TerrainControl Pro/TerrainCommand Pro) allows for applying the correct spray dosage during band spraying. Third, a sprayer can be equipped with active implement guidance and a GPS receiver. This creates an additional reference for the correct position of the spray boom and its nozzles above the bands. Therefore, the sprayer can be automatically steered to position the nozzles above the correct rows.

As an example, the following application of the vehicle 110 is explained. With the help of various agronomic analysis tools, a test design was developed and executed on a 20 hectare field. Once the test design for the different production strategies is designed, the field plan and machine settings are sent (e.g., via JDLink™, etc.) to the vehicle 110 at the plot of land. Then, the relevant settings are applied to the vehicle 110 (e.g., through AutoSetup™). All production steps are automatically documented in the online farm management system (e.g., John Deere Operations Center) for the field and the different design variants. After harvesting with the HarvestLab™ 3000 sensor, the yield and nutrient data are automatically transferred to the online farm management system for final analysis. The online farm management system allows optimization of local production systems based on regional conditions. Based on the recordation of the agricultural operations, farmers can measure the incremental improvements of different production decisions like different varieties, seed rates, fertilizer or crop protection strategies.

In this example, the traditional silage corn production was compared to variants of the agricultural production system applied above. The first major difference was the fertilizer strategy. In the conventional system, 100 kilogram nitrogen was broadcasted via a dribble bar system with subsequent field cultivator integration. In the agricultural production system, following Green Deal prescriptions, the 100 kilograms of nitrogen were incorporated with a strip-till application and during planting some micro-granulate with 2.5 kilograms of nitrogen was applied. In summary three different intensity levels have been executed: (1) for the conventional system, planting another 51.9 kg of nitrogen was applied; (2) for an example where 20% less mineral fertilizer was applied, the mineral fertilizer was reduced by 20% to 41.5 kg nitrogen; and (3) for an example where 100% less mineral fertilizer was applied, no additional mineral fertilizer was applied.

For all three fertilizer strategies, three different weed protection strategies were also executed: (1) for the conventional system, the weed strategy included broadcast spraying (e.g., no reduction in herbicides); (2) for the example where 20% less mineral fertilizer was applied, band spraying plus mechanical weeding was applied resulting in a 66% reduction in herbicides; and (3) for the example where 100% less mineral fertilizer was applied, mechanical weeding was exclusively applied (e.g., 100% reduction in herbicides).

As can be seen in the following table, nine production systems were evaluated in total:

| | | Strip-till | Strip-till |
|---|---|---|---|
| | | (20% less | (100% less |
| | Conventional | mineral fertilizer) | mineral fertilizer) |
| Broadcast spraying | Design 1 | Design 2 | Design 4 |
| Band spraying & | Design 4 | Design 5 | Design 6 |
| mechanical weeding | | | |
| Mechanical weeding | Design 7 | Design 8 | Design 9 |

The strip-till scenarios included nitrogen inhibitors in the slurry and variable rate seeding based on previous yield information, whereas the conventional method did not include nitrogen inhibitors and included a fixed seed rate. Preliminary results of the early crop development show enhanced crop establishment and advantages over the conventional system.

Flowcharts representative of example machine-readable instructions, which may be executed by programmable circuitry to implement and/or instantiate the agricultural operation circuitry of FIG. 2 and/or representative of example operations which may be performed by programmable circuitry to implement and/or instantiate the agricultural operation circuitry of FIG. 2, are shown in FIGS. 6-8. The machine-readable instructions may be one or more executable programs or portion(s) of one or more executable programs for execution by programmable circuitry such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 6-8, many other methods of implementing the example agricultural operation circuitry may alternatively be used. For example, the order of execution of the blocks of the flowcharts may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6-8 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 6 is a flowchart representative of example machine-readable instructions and/or example operations 600 that may be executed, instantiated, and/or performed by programmable circuitry to perform a desired agricultural operation. The example machine-readable instructions and/or the example operations 600 of FIG. 6 begin at block 610, at which the desired agricultural operation determination circuitry 210 is to determine a desired agricultural operation for a plot of land. The desired agricultural operation may include one or more agricultural operations to be performed to implement the desired agricultural operation (e.g., the desired agricultural operation is harvesting corn including a first agricultural operation of manure application and a second agricultural operation of planting, etc.). As described above, the desired agricultural operation may be determined by the desired agricultural operation through user input and/or through default prescriptions.

After the desired agricultural operation is determined, the first agricultural operation performance circuitry 220 causes performance of a first agricultural operation at block 620. In some examples, the first agricultural operation can include the desired agricultural operation or any other agricultural operation (e.g., an intermediate agricultural operation to facilitate the performance of the desired agricultural operation). Further, locations of the performance of the first agricultural operation are recorded for use in subsequent agricultural operations.

Then, at block 630, the second agricultural operation performance circuitry 230 causes performance of a second agricultural operation. In some examples, the second agricultural operation can include the desired agricultural operation or any other agricultural operation (e.g., an intermediate agricultural operation to facilitate the performance of the desired agricultural operation). The performance of the second agricultural operation occurs based on the location of the performance of the first agricultural operation (e.g., the first agricultural operation is performed at a first row, and the second agricultural operation is performed at the first row). Further, locations of the performance of the second agricultural operation are recorded for use in subsequent agricultural operations.

At block 640, the compilation circuitry 240 compiles performance data for the first agricultural operation and the second agricultural operation. In some examples, the compilation circuitry 240 compiles the first performance data and the second performance data to generate a combined performance data log showing the geographic location of the occurrence of the first agricultural operation and the second agricultural operation. In some examples, the compiled data can be used to effectuate the performance of a third agricultural operation. Further, a user may review the compiled data to plan further agricultural operations and/or to assess the performance of the vehicle.

FIG. 7 is a flowchart representative of example machine-readable instructions and/or example operations 620 that may be executed, instantiated, and/or performed by programmable circuitry to perform the first agricultural operation. The example machine-readable instructions and/or the example operations 620 of FIG. 7 begin at block 710, at which the first agricultural operation determination circuitry 222 is to determine a first agricultural operation to be performed on a plot of land. The first agricultural operation can be the desired agricultural operation, an intermediate agricultural operation required to instantiate the desired agricultural operation, and/or any other agricultural operation. In some examples, the first agricultural operation determination circuitry 222 receives the determination of the first agricultural operation from a user and/or a default prescription based on the desired agricultural operation and/or a previously performed agricultural operation. Further, in some examples, the first agricultural operation determination circuitry 222 may determine the first agricultural operation based on a default operation sequence implemented based on the desired agricultural operation determined by the desired agricultural operation determination circuitry 210 for the plot of land.

After the first agricultural operation is determined, at block 720, the first setting determination circuitry 224 determines a first setting for the first agricultural operation. The first setting for the first agricultural operation may include a setting of an implement attached to the vehicle to perform the first agricultural operation, a setting of the vehicle to perform the first agricultural operation, and/or any other modification that may be applied to the vehicle and/or implement to perform the first agricultural operation. In some examples, a first setting may not be applied (e.g., determined not necessary by a user, not necessary to effectuate the first agricultural operation, the user overrides application of the first setting, etc.). If the first setting is not determined for the first agricultural operation (block 720: NO), control proceeds to block 740.

If a first setting is determined for the first agricultural operation (block 720: YES), the first threshold determination circuitry 226 applies the first setting after the vehicle is a threshold distance from the plot of land, at block 730. The threshold distance may be any distance from the plot of land. Additionally, the threshold distance may be determined by default prescriptions and/or a user. Further, the first threshold determination circuitry 226 can apply the first setting after the vehicle is a threshold distance away from the plot of land and/or within a threshold distance from the plot of land. In some examples, a user may manually apply the first setting to the vehicle before and/or after arriving at the plot of land. In other examples, the first setting is automatically loaded to the vehicle by the first threshold determination circuitry 226.

At block 740, the first agricultural operation performance circuitry 220 causes a first performance of the first agricultural operation at a first row. The first performance of the first agricultural operation can include more than one row, one row, and/or a location of the first row.

Lastly, at block 750, the first performance recordation circuitry 228 records the first performance of the first agricultural operation. In some examples, the first performance recordation circuitry 228 records the location of the first performance of the first agricultural operation (e.g., georeferenced coordinate positions, etc.), conditions (e.g., wind, rain, angle of the plot of land, etc.), and/or sensor data (e.g., health of the soil, nutrient content, location of seeds in a row, locations of slurry bands, etc.) that may affect the placement of the first agricultural operation for subsequent agricultural operations. After the recording of the first performance of the first agricultural operation, control returns to block 630 of FIG. 6.

FIG. 8 is a flowchart representative of example machine-readable instructions and/or example operations 630 that may be executed, instantiated, and/or performed by programmable circuitry to perform the second agricultural operation. The example machine-readable instructions and/or the example operations 630 of FIG. 8 begin at block 810, at which the second agricultural operation determination circuitry 232 is to determine a second agricultural operation to be performed on a plot of land based on the first performance. The second agricultural operation can be the desired agricultural operation, an intermediate agricultural operation required to instantiate the desired agricultural operation, a subsequent agricultural operation based on the first agricultural operation, and/or any other agricultural operation. In some examples, the second agricultural operation determination circuitry 232 receives the determination of the first agricultural operation from a user and/or a default prescription based on a default operation sequence implemented based on the determined desired agricultural operation of the plot of land and/or the first agricultural operation.

After the second agricultural operation is determined, at block 820, the second setting determination circuitry 234 determines a second setting for the second agricultural operation. The second setting for the second agricultural operation may include a setting of an implement attached to the vehicle to perform the second agricultural operation, a setting of the vehicle to perform the second agricultural operation, and/or any other modification that may be applied to the vehicle and/or implement to perform the second agricultural operation. In some examples, the second setting determination circuitry 234 may not determine the second setting (e.g., determined not necessary by a user, not necessary to effectuate the second agricultural operation, the user overrides application of the first setting, etc.). If the second setting is not determined for the second agricultural operation (block 820: NO), control proceeds to block 740.

If a second setting is determined for the second agricultural operation (block 820: YES), the second threshold determination circuitry 226 applies the second setting after the vehicle is a threshold distance from the plot of land, at block 830. The threshold distance may be any distance from the plot of land. Additionally, the threshold distance may be determined by default prescriptions and/or a user. Further, the second threshold determination circuitry 226 can apply the second setting after the vehicle is a threshold distance away from the plot of land and/or within a threshold distance from the plot of land. In some examples, a user may manually apply the second setting to the vehicle before and/or after arriving at the plot of land. In other examples, the second setting is automatically loaded to the vehicle by the second threshold determination circuitry 226.

At block 840, the second agricultural operation performance circuitry 230 causes a second performance of the second agricultural operation at the first row. The second performance of the second agricultural operation can include more than one row, one row, and/or a location of the first row.

Lastly, at block 850, the second performance recordation circuitry 238 records the second performance of the second agricultural operation at the first row. In some examples, the second performance recordation circuitry 238 records the location of the second performance of the second agricultural operation (e.g., georeferenced coordinate positions, etc.) and/or conditions (e.g., wind, rain, angle of the plot of land, etc.) that may affect the placement of the second agricultural operation. In some examples, the second performance recordation circuitry 238 records the second performance based on the recordation of the first performance of the first row and a factor of the second performance of the second agricultural operation. The factor of the second performance of the second agricultural operation can include an elevation of the plot of land, an angle of the agricultural vehicle during performance of the second agricultural operation, and other external (e.g., relative to the vehicle) variables. After the recording of the second performance of the second agricultural operation, control returns to block 640 of FIG. 6.

FIG. 9 is a block diagram of an example programmable circuitry platform 900 structured to execute and/or instantiate the example machine-readable instructions and/or the example operations of FIGS. 6-8 to implement the agricultural operation circuitry of FIG. 2. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements the desired agricultural operation determination circuitry 210, the first agricultural operation performance circuitry 220, the second agricultural operation performance circuitry 230, and the compilation circuitry 240.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 932, which may be implemented by the machine-readable instructions of FIGS. 6-8, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowcharts of FIGS. 6-8 to effectively instantiate the circuitry of FIG. 2 as logic circuits to perform operations corresponding to those machine-readable instructions. In some such examples, the circuitry of FIG. 2 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine-readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine-readable instructions and/or operations represented by the flowcharts of FIGS. 6-8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry 912 of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine-readable instructions. However, once configured, the FPGA circuitry 1100 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine-readable instructions represented by the flowcharts of FIGS. 6-8 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine-readable instructions represented by the flowcharts of FIGS. 6-8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 6-8. As such, the FPGA circuitry 1100 may be configured and/or structured to effectively instantiate some or all of the operations/functions corresponding to the machine-readable instructions of the flowcharts of FIGS. 6-8 as dedicated logic circuits to perform the operations/functions corresponding to those software instructions in a dedicated manner analogous to an ASIC. Therefore, the FPGA circuitry 1100 may perform the operations/functions corresponding to the some or all of the machine-readable instructions of FIGS. 6-8 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine-readable instructions of FIGS. 6-8 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 10. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine-readable instructions represented by the flowcharts of FIGS. 6-8 to perform first operation(s)/function(s), the FPGA circuitry 1100 of FIG. 11 may be configured and/or structured to perform second operation(s)/function(s) corresponding to a second portion of the machine-readable instructions represented by the flowcharts of FIG. 6-8, and/or an ASIC may be configured and/or structured to perform third operation(s)/function(s) corresponding to a third portion of the machine-readable instructions represented by the flowcharts of FIGS. 6-8.

It should be understood that some or all of the circuitry of FIG. 2 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1000 of FIG. 10 may execute machine-readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 2 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 9, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

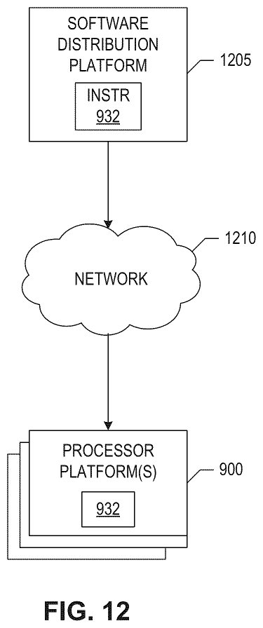

A block diagram illustrating an example software distribution platform 1205 to distribute software such as the example machine-readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine-readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine-readable instructions 932, which may correspond to the example machine-readable instructions of FIGS. 6-8, as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 932 from the software distribution platform 1205. For example, the software, which may correspond to the example machine-readable instructions of FIG. 6-8, may be downloaded to the example programmable circuitry platform 900, which is to execute the machine-readable instructions 932 to implement the agricultural operation circuitry. In some examples, one or more servers of the software distribution platform 1205 periodically offer, transmit, and/or force updates to the software (e.g., the example machine-readable instructions 932 of FIG. 9) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that determine and perform a second agricultural operation based on the recordation of performance of a first agricultural operation. Disclosed systems, apparatus, articles of manufacture, and methods improve the efficiency of using a computing device by recording the performance of a previous agricultural operation to facilitate the performance of a subsequent agricultural operation. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to determine agricultural operations for agricultural production are disclosed herein. Further examples and combinations thereof include the following:

Example 1 includes an agricultural system, comprising interface circuitry, machine-readable instructions, and at least one processor circuit to be programmed by the machine-readable instructions to determine a first agricultural operation to be performed on a plot of land, cause performance of the first agricultural operation on the plot of land, receive a record of the performance of the first agricultural operation, the record of the performance of the first agricultural operation to include first information related to a first row on the plot of land where the performance of the first agricultural operation occurred, determine a second agricultural operation to be performed on the plot of land, the determination of the second agricultural operation based on the first information, cause performance of the second agricultural operation, the performance of the second agricultural operation to occur at the first row, and receive a record of the performance of the second agricultural operation, the record of the performance of the second agricultural operation to include second information related to a second row on the plot of land where the performance of the second agricultural operation occurred, the second row based on the first row and a factor of the performance of the second agricultural operation.

Example 2 includes the agricultural system of example 1, wherein the factor of the performance of the second agricultural operation includes an elevation of the plot of land, an angle of an agricultural vehicle during performance of the second agricultural operation, and other external variables.

Example 3 includes the agricultural system of example 1 and example 2, wherein the recordation of the first agricultural operation further includes yield and nutrient data.

Example 4 includes the agricultural system of examples 1-3, wherein the first agricultural operation and the second agricultural operation include cover cropping, mulching, slurry injection, tilling, planting, mechanical weed control, band spraying, and harvesting.

Example 5 includes the agricultural system of examples 1-4, wherein to determine the first agricultural operation, one or more of the at least one processor circuit is to include determining a first setting of an agricultural vehicle to perform the first agricultural operation.

Example 6 includes the agricultural system of example 5, wherein, before performance of the first agricultural operation, one or more of the at least one processor circuit is to apply the first setting of the agricultural vehicle based on a distance of the agricultural vehicle from the plot of land.

Example 7 includes the agricultural system of examples 1-6, wherein the first agricultural operation is deposition of a slurry band and the second agricultural operation is planting of a seed, wherein the seed is planted at a location of the slurry band based on a reading from a sensor of the location of the slurry band.

Example 8 includes at least one non-transitory machine-readable medium comprising machine-readable instructions to cause at least one processor circuit to at least determine a first agricultural operation to be performed on a plot of land, cause performance of the first agricultural operation on the plot of land, receive a record of the performance of the first agricultural operation, the record of the performance of the first agricultural operation to include first information related to a first row on the plot of land where the performance of the first agricultural operation occurred, determine a second agricultural operation to be performed on the plot of land, the determination of the second agricultural operation based on the first information, cause performance of the second agricultural operation, the performance of the second agricultural operation to occur at the first row, and receive a record of the performance of the second agricultural operation, the record of the performance of the second agricultural operation to include second information related to a second row on the plot of land where the performance of the second agricultural operation occurred, the second row based on the first row and a factor of the performance of the second agricultural operation.

Example 9 includes the at least one non-transitory machine-readable medium of example 8, wherein the factor of the performance of the second agricultural operation includes an elevation of the plot of land, an angle of an agricultural vehicle during performance of the second agricultural operation, and other external variables.

Example 10 includes the at least one non-transitory machine-readable medium of example 8 and example 9, wherein the recordation of the first agricultural operation further includes yield and nutrient data.

Example 11 includes the at least one non-transitory machine-readable medium of examples 8-10, wherein the first agricultural operation and the second agricultural operation include cover cropping, mulching, slurry injection, tilling, planting, mechanical weed control, band spraying, and harvesting.

Example 12 includes the at least one non-transitory machine-readable medium of examples 8-11, wherein to determine the first agricultural operation, one or more of the at least one processor circuit is to determine a first setting of an agricultural vehicle to perform the first agricultural operation.

Example 13 includes the at least one non-transitory machine-readable medium of example 12, wherein, before performance of the first agricultural operation, one or more of the at least one processor circuit is to apply the first setting of the agricultural vehicle based on a distance of the agricultural vehicle from the plot of land.

Example 14 includes the at least one non-transitory machine-readable medium of examples 8-13, wherein the first agricultural operation is deposition of a slurry band and the second agricultural operation is planting of a seed, wherein the seed is planted at a location of the slurry band based on a reading from a sensor of the location of the slurry band.

Example 15 includes a method comprising determining a first agricultural operation to be performed on a plot of land, causing performance of the first agricultural operation on the plot of land, receiving a record of the performance of the first agricultural operation, the record of the performance of the first agricultural operation to include first information related to a first row on the plot of land where the performance of the first agricultural operation occurred, determining a second agricultural operation to be performed on the plot of land, the determination of the second agricultural operation based on the first information, causing performance of the second agricultural operation, the performance of the second agricultural operation to occur at the first row, and receiving a record of the performance of the second agricultural operation, the record of the performance of the second agricultural operation to include second information related to a second row where the performance of the second agricultural operation occurred, the second row based on the first row and a factor of the performance of the second agricultural operation.

Example 16 includes the method of example 15, wherein the factor of the performance of the second agricultural operation includes an elevation of the plot of land, an angle of an agricultural vehicle during performance of the second agricultural operation, and other external variables.

Example 17 includes the method of example 15 and example 16, wherein the first agricultural operation and the second agricultural operation include cover cropping, mulching, slurry injection, tilling, planting, mechanical weed control, band spraying, and harvesting.

Example 18 includes the method of examples 15-17, wherein to determine the first agricultural operation further includes determining a first setting of an agricultural vehicle to perform the first agricultural operation.

Example 19 includes the method of example 18, further including applying, before performance of the first agricultural operation, the first setting of the agricultural vehicle based on a distance of the agricultural vehicle from the plot of land.

Example 20 includes the method of examples 15-19, wherein the first agricultural operation is deposition of a slurry band and the second agricultural operation is planting of a seed, wherein the seed is planted at a location of the slurry band based on a reading from a sensor of the location of the slurry band.

The following claims are hereby incorporated into this Detailed Description by this reference. Although certain example systems, apparatus, articles of manufacture, and methods have been disclosed herein, the scope of coverage of this patent is not limited thereto. On the contrary. this patent covers all systems, apparatus, articles of manufacture. and methods fairly falling within the scope of the claims of this patent.

What is claimed is:

1. An agricultural system, comprising:
interface circuitry;
machine-readable instructions; and
at least one processor circuit to be programmed by the machine-readable instructions to:
determine a first agricultural operation to be performed on a plot of land;
cause performance of the first agricultural operation on the plot of land;
receive a record of the performance of the first agricultural operation, the record of the performance of the first agricultural operation to include first information related to a first row on the plot of land where the performance of the first agricultural operation occurred;
determine a second agricultural operation to be performed on the plot of land, the determination of the second agricultural operation based on the first information;
cause performance of the second agricultural operation, the performance of the second agricultural operation to occur at the first row; and
receive a record of the performance of the second agricultural operation, the record of the performance of the second agricultural operation to include second information related to a second row on the plot of land where the performance of the second agricultural operation occurred, the second row based on the first row and a factor of the performance of the second agricultural operation.

2. The agricultural system of claim 1, wherein the factor of the performance of the second agricultural operation includes an elevation of the plot of land, an angle of an agricultural vehicle during performance of the second agricultural operation, and other external variables.

3. The agricultural system of claim 1, wherein the record of the first agricultural operation further includes yield and nutrient data.

4. The agricultural system of claim 1, wherein the first agricultural operation and the second agricultural operation include cover cropping, mulching, slurry injection, tilling, planting, mechanical weed control, band spraying, and harvesting.

5. The agricultural system of claim 1, wherein to determine the first agricultural operation, one or more of the at least one processor circuit is to include determining a first setting of an agricultural vehicle to perform the first agricultural operation.

6. The agricultural system of claim 5, wherein, before performance of the first agricultural operation, one or more of the at least one processor circuit is to apply the first setting of the agricultural vehicle based on a distance of the agricultural vehicle from the plot of land.

7. The agricultural system of claim 1, wherein the first agricultural operation is deposition of a slurry band and the second agricultural operation is planting of a seed, wherein the seed is planted at a location of the slurry band based on a reading from a sensor of the location of the slurry band.

8. At least one non-transitory machine-readable medium comprising machine-readable instructions to cause at least one processor circuit to at least:
determine a first agricultural operation to be performed on a plot of land;
cause performance of the first agricultural operation on the plot of land;
receive a record of the performance of the first agricultural operation, the record of the performance of the first agricultural operation to include first information related to a first row on the plot of land where the performance of the first agricultural operation occurred;
determine a second agricultural operation to be performed on the plot of land, the determination of the second agricultural operation based on the first information;
cause performance of the second agricultural operation, the performance of the second agricultural operation to occur at the first row; and
receive a record of the performance of the second agricultural operation, the record of the performance of the second agricultural operation to include second information related to a second row on the plot of land where the performance of the second agricultural operation occurred, the second row based on the first row and a factor of the performance of the second agricultural operation.

9. The at least one non-transitory machine-readable medium of claim 8, wherein the factor of the performance of the second agricultural operation includes an elevation of the plot of land, an angle of an agricultural vehicle during performance of the second agricultural operation, and other external variables.

10. The at least one non-transitory machine-readable medium of claim 8, wherein the record of the first agricultural operation further includes yield and nutrient data.

11. The at least one non-transitory machine-readable medium of claim 8, wherein the first agricultural operation and the second agricultural operation include cover cropping, mulching, slurry injection, tilling, planting, mechanical weed control, band spraying, and harvesting.

12. The at least one non-transitory machine-readable medium of claim 8, wherein to determine the first agricultural operation, one or more of the at least one processor circuit is to determine a first setting of an agricultural vehicle to perform the first agricultural operation.

13. The at least one non-transitory machine-readable medium of claim 12, wherein, before performance of the first agricultural operation, one or more of the at least one processor circuit is to apply the first setting of the agricultural vehicle based on a distance of the agricultural vehicle from the plot of land.

14. The at least one non-transitory machine-readable medium of claim 8, wherein the first agricultural operation is deposition of a slurry band and the second agricultural operation is planting of a seed, wherein the seed is planted at a location of the slurry band based on a reading from a sensor of the location of the slurry band.

15. A method comprising:
determining a first agricultural operation to be performed on a plot of land;
causing performance of the first agricultural operation on the plot of land;
receiving a record of the performance of the first agricultural operation, the record of the performance of the first agricultural operation to include first information related to a first row on the plot of land where the performance of the first agricultural operation occurred;
determining a second agricultural operation to be performed on the plot of land, the determination of the second agricultural operation based on the first information;
causing performance of the second agricultural operation, the performance of the second agricultural operation to occur at the first row; and
receiving a record of the performance of the second agricultural operation, the record of the performance of the second agricultural operation to include second information related to a second row where the performance of the second agricultural operation occurred, the second row based on the first row and a factor of the performance of the second agricultural operation.

16. The method of claim 15, wherein the factor of the performance of the second agricultural operation includes an elevation of the plot of land, an angle of an agricultural vehicle during performance of the second agricultural operation, and other external variables.

17. The method of claim 15, wherein the first agricultural operation and the second agricultural operation include cover cropping, mulching, slurry injection, tilling, planting, mechanical weed control, band spraying, and harvesting.

18. The method of claim 15, wherein to determine the first agricultural operation further includes determining a first setting of an agricultural vehicle to perform the first agricultural operation.

19. The method of claim 18, further including applying, before performance of the first agricultural operation, the first setting of the agricultural vehicle based on a distance of the agricultural vehicle from the plot of land.

20. The method of claim 15, wherein the first agricultural operation is deposition of a slurry band and the second agricultural operation is planting of a seed, wherein the seed is planted at a location of the slurry band based on a reading from a sensor of the location of the slurry band.
